(19) United States
(12) Patent Application Publication
(10) Pub. No.: US 2010/0125521 A1
(43) Pub. Date: May 20, 2010

(54) Biller focused business to business electronic invoice presentment and accounts receivables reconciliation system

(76) Inventors: Christopher C. Hanan, Chicago, IL (US); Bukkapatnam Rama Mohan, Naperville, IL (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/308,182

(22) Filed: Dec. 3, 2002

Related U.S. Application Data
(60) Provisional application No. 60/334,586, filed on Dec. 3, 2001.

(51) Int. Cl. G06Q 40/00

(52) U.S. Cl. 705/40

(57) ABSTRACT

Billers and payers can resolve the disputes online and billers can pre-reconcile their systems with the changes. Payments received thru bank lockbox will be reconciled against the invoices and exceptions will be highlighted again allowing pre-reconciliation. The system allows a biller to present invoices over internet and interact with payors for efficient settlement of invoices. By eliminating the on-line payment initiation, the system will be able to drastically shorten the pilot timeframe and associated cost while still delivering a significant set of functionality and value to the user.

### CROSS REFERENCE TO RELATED APPLICATIONS

The present invention claims priority to U.S. Provisional Application No. 60/334,586 filed Dec. 3, 2001, the contents of which are incorporated herein by reference in their entirety.

### FIELD OF THE INVENTION

The present invention relates to a method and system for presentment and reconciliation of electronic invoices.

### BACKGROUND OF THE INVENTION

Electronic invoice payment and presentment (EIPP) systems have become widespread, but suffer from various deficiencies. First, the prior systems are biller-centric. The prior systems create value for the biller as the result of adoption by his/her customers. The prior systems are inconvenient for the customers or payors, because they require the payors to modify their disbursement practices. In fact, it is difficult to convince payors to adopt such systems because implementation is difficult.

Additionally, security concerns often arise with electronic payment and presentment systems. The systems must ensure appropriate levels of control including access control, data-security, and data-ownership.

Furthermore, the complexities involved in getting a sufficient number of counter-parties registered have deterred development of electronic invoice payment and presentment systems. Specifically, legal and risk considerations are associated with adding large numbers of users (specifically payors). Additionally, the registration process is typically cumbersome. A significant amount of information is required (e.g., bank account numbers, tax IDs, etc.). These complexities are sufficient to deter independent billers with insufficient sale-support and banks new at deploying high-complexity solutions in large numbers.

Accordingly, a system is needed that will maximize adoption by leveraging a bank's position, processes, existing infrastructure, investments, and customer base. Thus, electronic payment systems should be re-designed for bank-driven deployment. Furthermore, it would be advantageous to develop a system that minimizes network dependencies since network dependencies are one key reason for low adoption levels and long implementation times. It would also be an advantage if the system leverages and complements existing products.

Another advantage would be to create a solution that can bring immediate value to customers without any changes to existing business processes by leveraging a bank's lockbox relationships and processing capabilities and integrating the data-flows from the biller's invoices and the bank's lockbox operations.

Another drawback of existing systems is that they don not provide convenient and efficient methods for billers to reconcile their accounts receivable (A/R) systems. For example, most EIPP systems only provide for presentment of invoices to payors. Most existing systems do not have the capability for the biller to pre-reconcile A/R systems.

In addition, many existing lockbox systems do not interface or integrate with existing EIPP systems. For example, any data transmission a biller may receive from a lockbox does not integrate with or update most EIPP systems leaving the biller to reconcile the lockbox data separately (e.g., by manual or other techniques). Other drawbacks also exist.

### BRIEF SUMMARY OF THE INVENTION

One feature of the invention is that it integrates electronic invoice presentment with a bank lockbox or other secure clearinghouse procedure to bring immediate value to users without a need to await mass adoption.

Another feature of the invention is that it removes the need to implement electronic payment solutions, eliminates changes to payers disbursement processes, pre-reconciles invoices with payments and eliminates changes to billers' reconciliation processes.

Another feature of the invention is that it eliminates exception processing by capturing all invoices presented and all payments received at as few as two integration points.

The present invention creates a secure image of an invoice accessible to the biller's payors or customers through the Internet or other computer-based network. The payors have the option to view the invoice and adjudicate any disputes prior to payment. However, once a payment decision has been made, the payor uses his/her standard funds disbursement processes (e.g., check, wire transfer, etc.). By integrating the system with a data-feed from a bank's lockbox operations, the system is able to pre-determine which invoices were paid in full and thus can be applied cleanly to the biller's cash ledger. Where discrepancies exist, the system can engage in post-payment dispute resolution. One feature of this pre-reconciliation capability is that it creates significant value for the biller's cash application process even if none of the biller's customers utilize the system's dispute adjudication capabilities.

Some existing EIPP solution providers have replaced the payment mechanisms and have not ventured into leveraging the existing bank infrastructure and lockbox processes. In contrast, by utilizing the existing infrastructure, the present system coexists with traditional processes instead of displacing them completely, thereby avoiding the traditional pitfalls of network dependencies.

The system captures biller invoices from the biller's accounting or other enterprise resource program (ERP) systems and presents them electronically. Billers and payers can resolve the disputes online and billers can pre-reconcile their accounts receivable (A/R) systems with the changes. Payments received through a bank lockbox will be reconciled against the invoices and exceptions will be highlighted again allowing pre-reconciliation.

The system allows a biller to present invoices over the Internet or other computer-based network and interact with payors for efficient settlement of invoices. By eliminating the requirement for on-line payment initiation, the system will be able to drastically shorten the pilot timeframe and associated cost while still delivering a significant functionality and value to the user.

Another feature of the invention is that it provides for reconciliation of invoice presentment and payment data with a biller's existing A/R systems. For example, the invention enables payment data from a biller's lockbox to be matched with invoice presentment data. The matching data enables updating and reconciliation of the biller's A/R systems.

Another feature of the invention is that it enables any changes or modifications to the invoices to be reflected in the biller's A/r systems. For example, the invention enables a biller and a payor to conduct a collaborative, online resolution of a disputed invoice and agree to revise the amount due. The electronic invoice may then be updated to reflect the new amount and, after payment is received at a lockbox, the payment information obtained from the lockbox data will be applied to the revised invoice and in the biller's A/R systems.

### BRIEF DESCRIPTION OF THE DRAWINGS

The present invention can be understood more completely by reading the following Detailed Description Of Exemplary Embodiments, in conjunction with the accompanying drawings.

FIG. 1 is a schematic of an overall system according to an embodiment of the invention.

FIG. 2 is a flow chart showing biller hub process flow according to embodiments of the invention.

FIG. 3 is a flow chart illustrating a further process flow according to embodiments of the invention.

### DETAILED DESCRIPTION OF EXEMPLARY EMBODIMENTS

The above-identified figures and the following description provide an overview of a biller hub implementation of an electronic invoice presentment and reconciliation system invention. The invention may rely on industry-standard software components for some basic processing functions. The process solution may be implemented in software, firmware or other computer readable formats and deployed in a secure operational site or other locations.

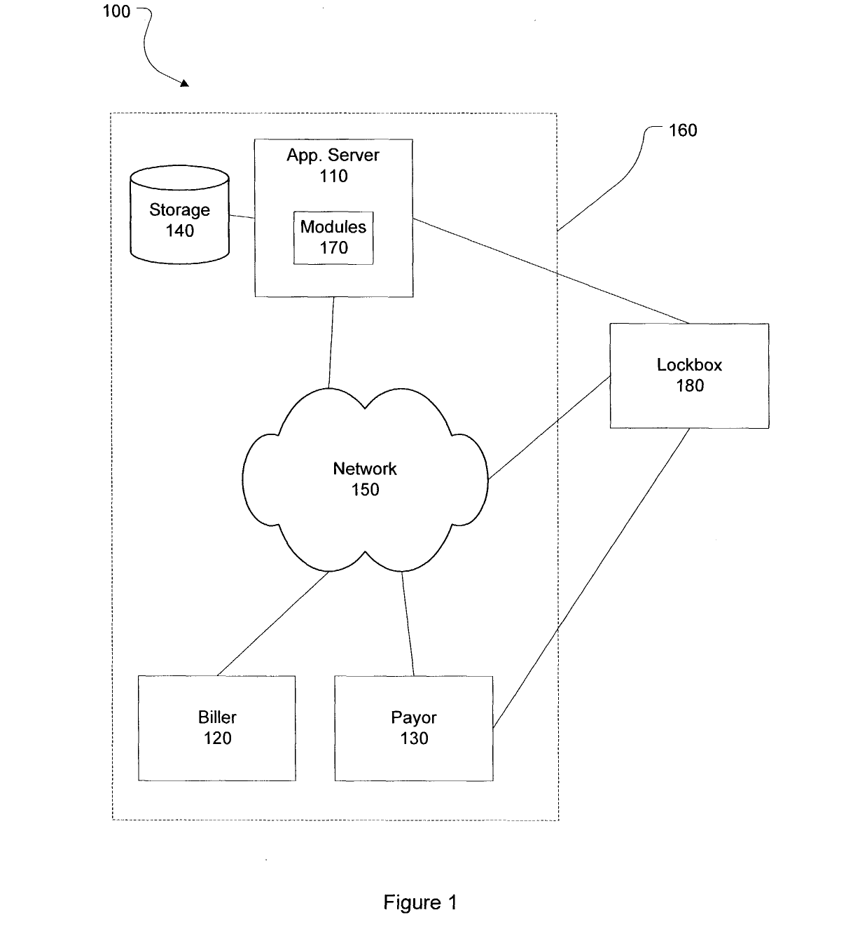

As shown in FIG. 1, system 100 may comprise one or more computer-based components (e.g., application server 110, biller 120, payor 130, etc.). Although, only one of each is shown, any number of computer-based components may be used. In addition, it is to be understood that biller 120, payor 130 and other various entities described herein may employ a computer to implement the components performing the herein described functions. According to an embodiment of the invention, a computer may be a standard computer comprising an input device, an output device, a processor device, and data storage device. According to other embodiments of the invention, various components may be different department computers within the same corporation or entity. Other computer configurations may also be used. According to another embodiment of the invention, various components may be separate entities such as corporations or limited liability companies. Other embodiments, in compliance with applicable laws and regulations, may also be used.

The computer-based components of the invention (e.g., 110, 120, 130, etc.) may comprise any known types of computer (e.g., PC, Mac, server, workstation, laptop, personal digital assistant (PDA), etc.). The computer components may operate using any of a variety of operating programs, such as a Microsoft Windows 98™ Windows 2000™, Windows XP™, Linux, Macintosh OS, or other operating system.

The system 100 may also comprise a plurality of storage devices 140 which may include any suitable storage device, such as a database, hard drive, a CD-ROM, or an optical disc, etc. Other storage devices 140 are also possible.

The system 100 may also enable communication between billers 120, payors 130 and other system components by using a communication interface to other computers via a network 150. The network 150 may comprise the Internet, an intranet, a Personal Area Network (PAN), a Local Area Network (LAN), a Wide Area Network (WAN), a Metropolitan Area Network (MAN), or another similar type of network. The network 150 may alternatively use wireless technology to connect a plurality of computers together. The network 150 can operate using any network-enabled code, such as a Hyper Text Markup Language (HTML), a Dynamic HTML, an Extensible Markup Language (XML), an Extensible Stylesheet Language (XSL), a Document Style Semantics and Specification Language (DSSSL), a Java™ language, etc.

A biller hub 160 may comprise a biller 120, payors 130, application server 110 and the associated application modules 170. Application modules 170 are understood to be computer readable code (e.g., software, firmware, etc.) that enables the various computer-based system components to carry out the functions described herein. While shown residing on application server 110, it is also to be understood that application modules 170 may be distributed throughout system 100 (i.e., various modules or parts of modules may reside at biller 120, payor 130, etc.), on more than one server, or in some other suitable configuration.

To participate in the “Biller Hub,” a biller 120 may register itself and its payors 130 in the system 100. The system 100 has the capability to capture extensive information about the biller 120 and payor 130. Additionally the application 170 will allow the biller 120 to mass-enroll its payors 130 through a batch file upload process. Billers 120 can also send invitations to the payors 130 to participate in the biller hub 160.

Billers 120 can upload invoices to the system 100 for online presentment. The invoice format may be customized for each biller 120. The system 100 allows both online creation and batch upload of invoices. In the case of batch upload, the system 100 supports multiple formats of files (e.g., CSV files, XML files, etc.). The biller 120 can select an appropriate file format for upload. By allowing significant flexibility in the specific formats taken in, the system 100 aims to reduce the setup and configuration efforts required from the biller 120.

The payors 130 can view the invoices and settle any disputes online. Additionally payors 130 can download the invoice details in an appropriate format (e.g., CSV, XML, etc.) to subsequently upload into their ERP systems. Optionally, the download format can be customized for any payor 130.

Billers 120 can download the invoice modifications to update their ERP systems. This helps in pre-reconciling the payments and ensures payments will be posted without exceptions. There is relatively little or no change to the payor's 130 disbursement processes. Payors 130 can pay the electronic invoices exactly as they currently pay paper invoices. The payment methods can be check, automated clearing house (ACH) (i.e., direct deposit), wire transfer, or any other known form of funds transfer.

In some embodiments, the biller 120 may have a lockbox 180 with a sponsoring bank or other financial institution to capture payments. The lockbox 180 may also have a data capture option turned on to get invoice details. The details captured by lockbox 180 may be updated on the invoices.

Creation of a biller hub 160 may involve the participation of many parties. The main tasks are Biller enrollment, invoice, format customization, negotiation of file formats, setting up the file transfer schedules and establishing a lockbox interface.

Biller Enrollment is the process of capturing relevant business information from the biller 120, validating the information collected and registering the biller 120 in a database. In some embodiments, the system 100 may provide screens or other interfaces to collect biller 120 data. The biller 120 may choose to allow access to multiple personnel. A system administrator may create user codes and passwords for all users specified by the biller 120. Other security procedures may also be used.

A biller 120 may have an option of choosing from available invoice formats or designing a custom invoice format for its special needs. The invoice format may then be associated with the biller 120 and invoices created by the biller 120 may use this format by default.

The administration of multiple biller hubs 160 maybe done by a central administrator (not shown). The central administrator may perform the biller 120 registration, user creation and password setting.

A payor 130 enrollment file format may be defined by a system administrator or other appropriate personnel and made available to the biller 120 at the time of biller 120 registration. The biller 120 may create a payor 130 enrollment file with all the necessary information for creating a list of the biller's 120 payors 130 as participants for the biller hub 160. The biller 120 then may transfer the payor 130 enrollment file created with all the information on to the application server 110. This may be done by accessing an admistrative module or interface (e.g., an “Administration” tab, etc.) and accessing a simple file-upload and selection dialog. After successful transfer, server 110 may send email notification to the biller 120. The server 110 may send email notifications to both a biller contact person, the user who initiated the transfer, or any other predetermined email address.

A system central administrator may initiate the file processing by any suitable method (e.g., by clicking on “Upload participants” in an administrator graphic user interface (GUI), etc.). The payors 130 may also be added in a biller's 120 address book with the role of “payor” with appropriate customer numbers or other identifiers.

A temporary user code and password may be created for each of the payors 130. For example, the contact email address provided by the biller 120 may be the temporary user name for the payor 130 and the customer number may be the password. In addition, checksum operations or other security measures may be implemented. For example, if an email address is above a set number, such as for example thirty (30) characters, the email address would be rejected.

After successful upload, the server 110 may send email notifications about the file processing completion status to the user who transferred the file, the biller contact person, the system administrator, or any other appropriate email address. In case of errors, an error file may be sent as an email attachment.

In some embodiments, a biller 120 may also have the ability to view the address book, which may be stored in storage device 140 or some other suitable location. The address book functionality may be enhanced to show the status of the payor 130. A payor 130 who has never accessed the system 100 will have an “inactive” status, a payor 130 who has logged on to the system 100 at least one time may have an “active” status.

From an administration screen or other interface (e.g., GUI), a biller 120 may browse the address book and view all the payors 130 who have not registered in the biller hub 160. The biller 120 may send unregistered payors 130 email notifications of their temporary registration in the biller hub 160. The email notification may also carry a temporary user code and password created for the payor 130. In an embodiment of the invention, there is no limit to the number of times a biller 120 can invite payor 130 to join.

The system 100 may also provide a process for payors 130 to remove a temporary status. For example, when the payors 130 log into the system 100 for the first time using the temporary user code and password, they may be prompted to change their temporary password.

In addition, some embodiments of the system may provide “click through” licenses or other mechanisms to clarify the contractual obligations of the parties. For example, a screen or other interface displaying terms and conditions associated with use of the system 100 may be displayed with an “Agree” and a “Cancel” option.

As described herein, various features of some embodiments of the invention may be accessible based upon the assigned role of the participants. For example, participants in biller hub 160 can have the roles of biller 120 or payor 130. Payors 130 may have the lowest level of access to the system. However, payors 130 may receive the daily notifications indicating the new invoices submitted to them. Payors 130 may also view, modify and approve the invoices and authorize payments. They can participate in online dispute resolution. They can also download the invoice data to their ERP systems. One function that may not be allowed to the payor 130 is the creation of an invoice (both online and batch). This means a “Payor” does not have access to any of the “Biller” functions unless the payor 130 also registers as a biller 120. If an unauthorized payor 130 clicks on or otherwise selects a biller-related link, a page or other error message is displayed denying access.

In some embodiments, the biller 120 may have full privileges to the system's functionality. For example, billers 120 may create invoices and submit them to the payors 130. Billers 120 may approve the invoice modifications and download data for pre-reconciliation. Billers 120 may also receive the daily summary notifications on the invoices submitted to all payors 130. Billers 120 may also be payors 130 with respect to other billers 120 and can avail all payor 130 features.

The payee/biller may also have access to a number of processes. For example, a biller 120 may create invoices by manual online entry, by file upload or by other appropriate method. In some embodiments, the biller 120 may access an invoice creation process at any time. For example, even if the biller 120 generally uploads the invoices, a manual entry option can be used to enter any one-off invoices.

Manual invoice creation processes may comprise any suitable procedure. For example, manual invoice creation may comprise the following features. Pre-defined invoice formats may be supported by the system and may be available for the biller 120 along with a customizable “Universal invoice” format. A biller's logo, name or other insignia may be attached to the invoice format. A manually created invoice may undergo a verification process workflow or other review process.

As discussed herein, invoices may also be created in batches. Batch invoice creation may comprise the following features. The biller 120 may upload invoices using the default format assigned by the administrator. The invoice file may be created by the biller 120 on a workstation or desktop personal computer. The meta-data file may be available on the system application server 110. The uploaded invoice file may then be placed on the system application server 110. The invoice files may be uploaded into a database or other storage at pre-configured intervals. Biller 120 receives email notifications after the invoices are uploaded into the database 140. Errors may be sent as email attachments or other messages. The invoices uploaded may not undergo a verification process workflow like the manually created invoices. Invoices uploaded may be submitted directly to the “payor.” Along with the step as mentioned above, the file upload processing will happen in a CRON job scheduled to run once every day.

As described herein, embodiments of the invention may also support various accounts receivable (A/R) functions. For example, in order to effect offline reconciliation, the biller 120 may download the invoices in any supported format to update the A/R systems. This helps in pre-reconciling the invoices and error free posting of payments. Biller 120 can also download the invoices disputed by the payors. After verifying the changes in the A/R system, the biller 120 can upload the changes to the invoices. It is assumed that the invoice number is unique for a biller 120. The system may reject duplicate invoice numbers from the same biller 120.

Likewise, embodiments of the invention support various accounts payable (A/P) functions. For example, payors 130 may also have access to a number of A/P processes. The “payor” could choose to reconcile invoices in two ways depending on the volume of invoices paid and the sophistication of their accounts payable (A/P) systems. Low volume payors 130 can opt to do the invoice processing completely online. Payors 130 with ERP systems can download the data into their system and process invoices offline.

In addition, the invention enables online A/R and A/P functions. For example, the payor 130 may perform online reconciliation to modify, approve, authorize and dispute invoices online as currently implemented in the system application. The payor 130 may use a PC or other computer with a standard web browser for this functionality. The system may not prevent the modification of authorized invoices as the payors 130 are not obligated by their commitment to pay as authorized. Authorization may comprise an indication of payor's willingness to pay and can be revoked. Additionally, the payor 130 may modify the total amount of the invoice without modifying at the line item level. Invoice total amount can be modified from at summary list level or in invoice detail screen. When invoice total is modified, a user may select a button or otherwise select to get a dialog box or other interface and enter invoice level comments. The invoice totals may not be recomputed automatically when line items are later modified. A warning dialog box may be displayed when a user modifies the line item details of an invoice modified at a higher level. Users may also select a recalculate button to override the invoice level changes.

In some embodiments, the payor 130 may also perform offline reconciliation. For example, payors 130 may download the invoices in formats supported by application 110 and do necessary changes offline (e.g., on their ERP systems). The payors 130 may then upload changes to invoices through flat files or other outputs created from their ERP systems. Invoice download functionality may be provided for each invoice state screen available in the system. This allows the payors 130 to download the newly submitted invoices, verified invoices, approved invoices and authorized invoices separately. The downloaded file will contain only the invoices not downloaded previously. The payor 130 may also select a different file format for each download. The meta-data file will be available on the system application server 110 for every supported down load format. Download files may be created at pre-configured intervals and may be emailed to the payor 130. Payors 130 can also chose different formats for file uploads depending on their ERP systems. The files sent to a server 110 may be loaded into database 140 at pre-configured intervals. The system 100 may generate email notifications to payors 130 after successful file transfer and upload.

In some embodiments, the invoice download functionality may also be available for the “biller” in the invoice dispute resolution screen. For example, downloads on the payee/biller end may be similar to the above-described ones provided at the payor 130 end The download may be based on the invoice states chosen by the biller 120.

Some embodiments of the invention provide for payment handling functions. For example, the system may include mechanisms for posting the payments received to the payors 130 and the invoices. Different options are possible depending on the sophistication of the biller 120. Online initiation of payments may also be available.

In some embodiments payment may be handled via pre-reconciliation. Pre-reconciliation is a relatively simple payment handling option. For example, one solution is to keep the biller's A/R system in sync with the expected payments before payments are received. Posting of cash may complete without exceptions if the expected payments and actual payments match. Since the payor 130 is expected to have negotiated the invoice payment amounts online and the authorized amount indicates the final payment including all discounts, the biller 120 may download the authorized invoices from the system in a format of choice and update their A/R.

Some embodiments enable payment handling with relatively little or no change to existing payment processing at the biller 120 or the payor 130. For example, existing payments processing may continue via the system 100. There are no additional delays introduced in payment handling. There will be relatively few if any exceptions as long as the actual payment amount matches the payment authorized by payor 130. If the payor 130 does not authorize the invoice prior to payment, the invoice total may be considered as the authorized amount. If the invoice was modified and disputed, the final amount may be the authorized amount. After receiving and processing payments and doing any post payment disputing, the biller 120 may upload a file containing the invoices to be closed. Once closed the invoice is not available for modifications and closed invoices will be archived and deleted.

In some embodiments, lockbox 180 integration is another payment handling option. Many relatively frequent billers 120 with a large number of payments and invoices may already have lockboxes 180 with a bank or other financial institution to expedite payment processing. For example, the biller 120 may subscribe to a wholesale lockbox 180 with Data-keying and electronic transmission of results or a Receipt$tream^{SM} lockbox 180 offered by Bank One™.

In some embodiments, the lockbox 180 processes may work similarly to a trust account concept without the need for complex cash management processes. Also, a biller lockbox 180 may eliminate any delay associated in sending money to a trust fund. The funds need not be aged as the payor 130 is directly paying the biller 120.

Embodiments of the system may have an additional actual payment amount field for the invoices. The amount captured by the lockbox 180 may be updated on the invoices through a file-upload from the lockbox operations. The file may be processed by the system central administrator or other appropriate process. The biller 120 may download the invoices paid and update the A/R system with actual payment details. The biller 120 may also receive the lockbox 180 transmission.

Embodiments of the invention provide for payment handling with alternatives that de-emphasize cash management functionality. These processes may circumvent the problems in handling cash as the biller hub 160 administrator may not be a bank. Some processes that emphasize cash management functionality can impose significant delays to payment settlement and are relatively difficult to setup and manage.

In some embodiments, the biller hub 160 administrator may modify or customize certain system aspects. For example, invoice presentation may be altered by revamping exiting screens to conform to the sponsoring bank (or other administrator) look and feel. The colors, fonts and presentation layouts may be compatible with other sponsoring bank applications. Furthermore, technology upgrades may include integration with any or all of: Solaris 2.8; Weblogic 6.1; and Oracle 9i.

The invention may be deployed as a shared service for all potential billers 120 and payors 130. An administrator (e.g., a bank) may periodically upgrade the implementation with enhancements.

Embodiments of the invention may integrate data from electronic invoices and lockbox 180 data. For example, lockbox 180 may comprise a typical lockbox system (e.g., as provided by a bank or other check clearinghouse) wherein the lockbox 180 systems collect data from payor payments received at the lockbox 180. In some embodiments, some lockbox 180 information may be captured from information on the payment instruments (e.g., from magnetic ink character recognition (MICR) data imprinted on a check). The collected data may comprise payee information (e.g., biller's name, account, etc.), payor 130 information (e.g., amount of payment, account number, check number, other MICR information, etc.) and other information. The lockbox 180 data may then be integrated with the invoice data (e.g., via a module 170 implemented by server 110) by, for example, updating invoices to reflect received payments. The updated invoice information, which incorporates lockbox 180 data, may then be applied (e.g., via a module 170 implemented by server 110) to the biller's 120 A/R systems. Thus, it is possible for the system 100 to enable biller's 120 to reconcile invoices (e.g., in their A/R systems) from the integration of data from lockbox 180 and the electronic invoices created by biller 120 as described herein.

Embodiments of the invention also enable reconciliation processes to include any modifications to biller 120 invoices. For example, payor 130 and biller 120 may engage in an online resolution of a disputed invoice and agree to adjust the amount due. As a result of the online resolution, the invoice may be updated to reflect a new amount due (e.g., via a module 170 implemented by server 110). When the new payment amount is received (e.g., at lockbox 180), lockbox 180 data may be integrated with the updated invoice data and the biller's A/R systems may receive an indication that the updated invoice has been paid in full. Other reconciliation processes are also possible.

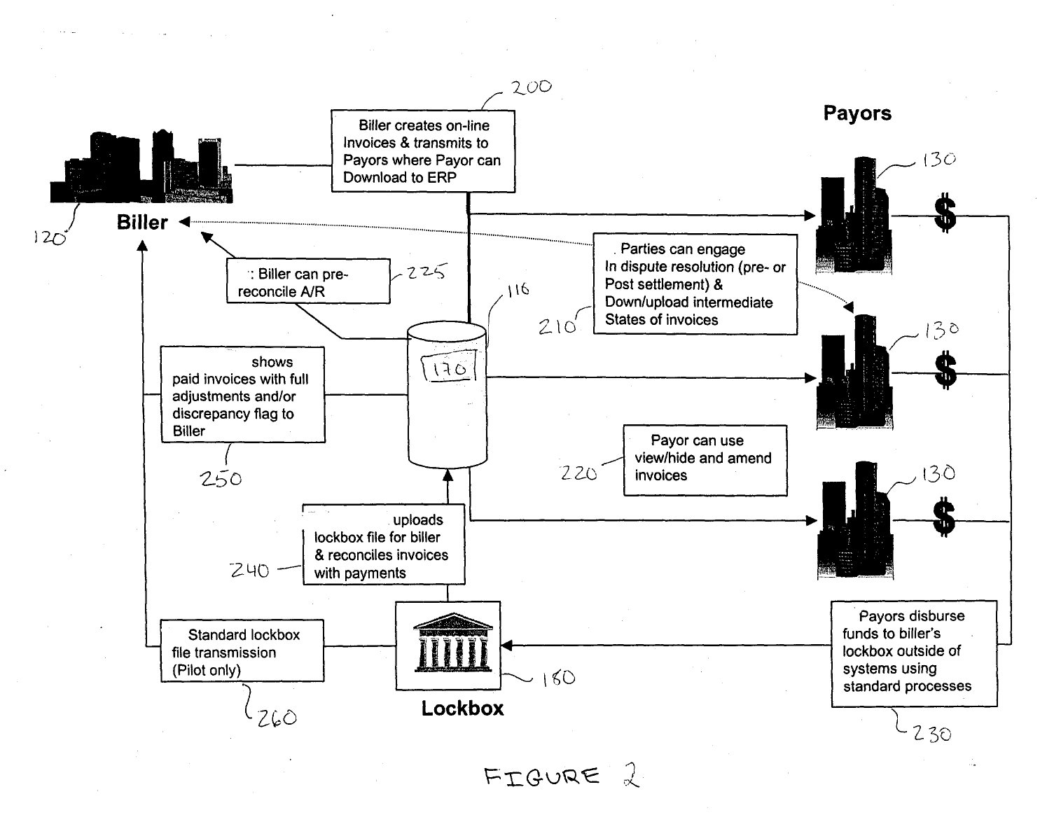

FIG. 2 is a schematic representation of a biller hub 160 process flow according to, embodiments of the invention. As shown, a process may initiate, as indicated at 200, when a biller 120 creates an on-line invoice or invoices and transmits (e.g., via network 150) them to the payors 130. The payors 130 may then download or otherwise view the invoices. As indicated at 210, biller 120 and payors 130 may engage in dispute resolution (e.g., on-line) or other intermediate steps and download or otherwise access updated invoices. At 220 payors may continue to view and amend invoices as desired. At 225 biller 120 may pre-reconcile A/R systems based, at least in part, on the accessed invoice information. As indicated at 230, payors disburse funds to biller's 120 lockbox 180 (e.g., using standard processes). As indicated at 240, lockbox 180 information may be uploaded and integrated with invoice information (e.g., via one or more modules 170 on server 110). At 250, biller's 120 A/R systems may be updated (e.g., via one or more modules 170 on server 110). In some embodiments, biller 120 may also receive standard lockbox 180 data transmissions as indicated at 260.

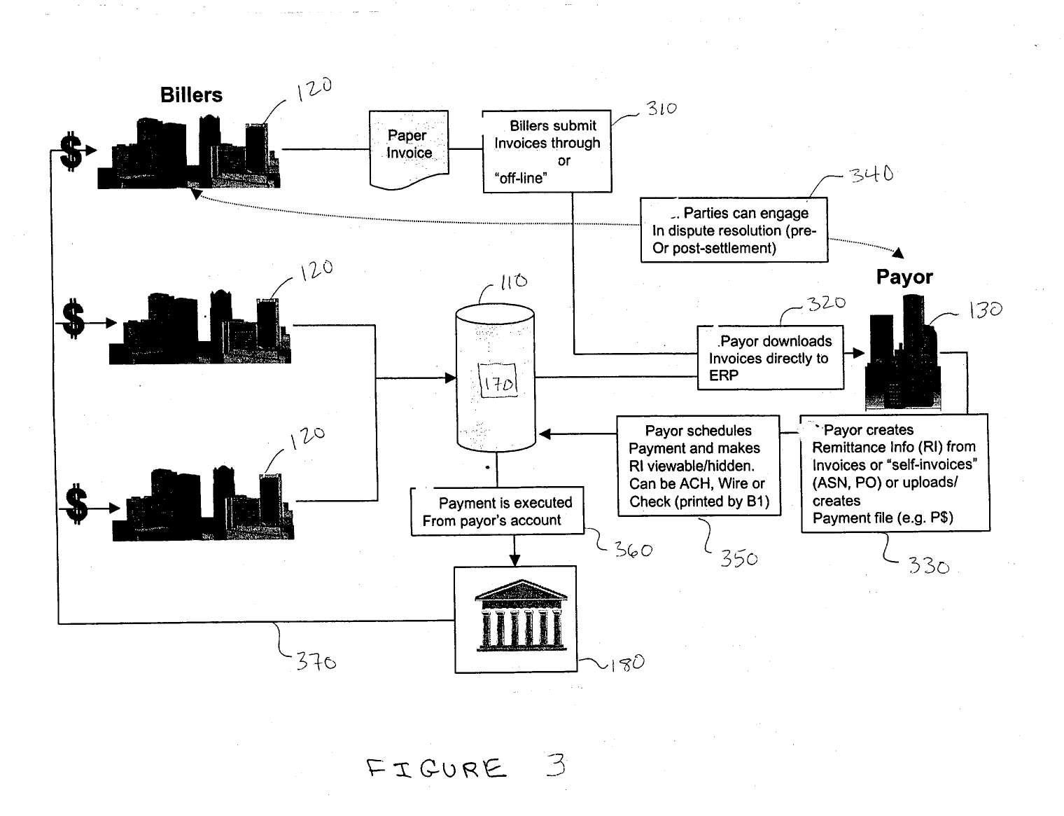

FIG. 3 is a schematic representation of a payor hub process flow according to embodiments of the invention. As indicated at 310, a biller 120 may issue a paper invoice or, as indicated at 315, a biller 120 may issue an electronic invoice. At 320, payor 130 may download or otherwise view the invoices. In some embodiments, payor 130 may create remittance information as indicated at 330. Billers 120 and payor 130 may engage in dispute resolution (e.g., online) as indicated at 340. At 350, payor 130 may schedule payment (e.g., via one or more modules 170 on server 110). At 360 payment may be executed from payor's 130 account (e.g., via one or more modules 170 on server 110) to lockbox 180. In some embodiments, biller 120 and payor 130 may engage in dispute resolution (e.g., as indicated at 340) after payment is executed. As indicated at 370 payment may be delivered to bilers 120 via usual lockbox 180 procedures.

More generally, while the foregoing description includes details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents

1. A computer implemented method for invoice presentment and reconciliation wherein the method is executed by a programmed computer processor which communicates via a computer based network, the method comprising:
enabling a biller to present an invoice, comprising invoice information, to a payor over the computer based network;
receiving lockbox information from a lockbox by the biller, wherein the lockbox information comprises payment information relating to a payment by the payor following presentment of the invoice by the biller wherein the payment is remitted by the payor to the lockbox;
integrating the payment information from the lockbox and the invoice information to create reconciliation information using the programmed computer processor;
providing the reconciliation information to the biller;
enabling the payor and the biller to conduct an online reconciliation of the invoice over the computer based network following invoice receipt, wherein the online reconciliation comprises one or more of modifying, disputing, approving, and authorizing the invoice; and
enabling the biller and the payor to conduct a collaborative dispute resolution process over the computer based network at least in part based on the online reconciliation.

2. (canceled)

3. The method of claim 1 wherein the collaborative dispute resolution process comprises updating the invoice to reflect modifications to the invoice.

4. The method of claim 1, further comprising:
reconciling an accounts receivable system associated with the biller using the reconciliation information.

5. A computer implemented system for invoice presentment and reconciliation, the system comprising:
an application server for hosting modules comprising the computer implemented system wherein the application server comprises at least one processing device, at least one input device, and at least one output device;
a plurality of storage devices for storing data associated with the computer implemented system wherein at least one of the plurality of storage devices is connected to the application server;
an invoice presentation module for enabling a biller to present an invoice, comprising invoice information, to a payor over a computer based network;
a lockbox information module for receiving lockbox information by the biller from a lockbox, wherein the lockbox information comprises payment information relating to a payor payment remitted to the lockbox, and for matching the received lockbox information with the invoice information;
an integration module for integrating the payment information from the lockbox and the invoice information to create reconciliation information, the reconciliation information relating to the payor payment;
a reconciliation module for providing the reconciliation information to the biller and for enabling the payor and the biller to conduct an online reconciliation of the invoice over the computer based network, wherein the online reconciliation comprises one or more of modifying, disputing, approving, and authorizing the invoice; and
a resolution module for enabling the biller and the payor to conduct a collaborative dispute resolution process over the computer based network.

6. (canceled)

7. The system of claim 5 wherein the collaborative dispute resolution process comprises updating the invoice to reflect modifications to the invoice.

8. The system of claim 5 wherein the reconciliation module further comprises:
an accounts receivable module for reconciling an accounts receivable system associated with the biller using the reconciliation information.

9. A computer implemented method for electronic invoice presentment and reconciliation wherein the method is executed by a programmed computer processor which communicates via a computer based network, the method comprising:
providing an application server to host applications comprising the computer implemented method wherein the application server comprises at least one processing device, at least one input device, and at least one output device;
storing data from the computer implemented method in a plurality of storage devices connected to the application server;
accepting a registration of a biller, wherein the biller registers by inputting information into the computer based network;
enabling the biller to create an enrollment file comprising payor information;
accepting the enrollment file into the computer based network;
creating an address entry for a payor, wherein the address entry is created based, at least in part, from the payor information in the enrollment file;
enabling the biller to create an invoice and enter the invoice into the computer based network;
enabling the payor to view the invoice over the computer based network;
enabling the payor and the biller to conduct an online reconciliation of the invoice over the computer based network, wherein the reconciliation may comprise any of modifying, disputing, approving, and authorizing the invoice;
receiving lockbox information by the biller from a lockbox, wherein the lockbox information comprises payment information relating to a payor payment remitted to the lockbox;
integrating the payment information from the lockbox and the invoice information to create reconciliation information using the programmed computer processor;
providing the reconciliation information to the biller; and
enabling the biller and the payor to conduct a collaborative dispute resolution process over the computer based network.

10. The method of claim 9 further comprising:
enabling the biller to invite the payor to register with the computer based network.

11. The method of claim 9 further comprising:
enabling the payor to download the invoice and conduct an offline reconciliation of the invoice.

12. The method of claim 9 further comprising:
enabling the biller to download the invoice and conduct an offline reconciliation of the invoice.

13. The method of claim 9 further comprising:
enabling the biller to receive payment from the payor via a lockbox mechanism; and
updating the invoice to indicate receipt of payment.

14. A computer based system for electronic invoice presentment and reconciliation, the system comprising:
an application server for hosting modules comprising the computer based system wherein the application server comprises at least one processing device, at least one input device, and at least one output device;
a plurality of storage devices for storing data associated with the computer based system wherein at least one of the plurality of storage devices is connected to the application server;
a registration acceptance module for accepting a registration of a biller, wherein the biller registers by inputting information into a computer based network;
an enrollment module for enabling the biller to create an enrollment file comprising payor information;
an enrollment acceptance module for accepting the enrollment file into the computer based network;
an address book module for creating an address entry for a payor, wherein the address entry is created based, at least in part, from the payor information in the enrollment file;
an invoice module for enabling the biller to create an invoice and enter the invoice into the computer based network;
an invoice display module for enabling the payor to view the invoice over the computer based network;
a reconciliation module for enabling the payor and the biller to conduct an online reconciliation of the invoice over the computer based network, wherein the reconciliation may comprise any of modifying, disputing, approving, and authorizing the invoice;
a receiving module for receiving lockbox information by the biller from a lockbox, wherein the lockbox information comprises payment information relating to a payor payment remitted to the lockbox;
an integration module for integrating the payment information from the lockbox and the invoice information to create reconciliation information and for providing the reconciliation information to the biller; and
a resolution module for enabling the biller and the payor to conduct a collaborative dispute resolution process over the computer based network.

15. The system of claim 14 further comprising:
an invitation module for enabling the biller to invite the payor to register with the computer based network.

16. The system of claim 14 further comprising:
a download module for enabling the payor to download the invoice and conduct an offline reconciliation of the invoice.

17. The system of claim 14 further comprising:
a download module for enabling the biller to download the invoice and conduct an offline reconciliation of the invoice.

18. The system of claim 14 further comprising:
a payment module for enabling the biller to receive payment from the payor via a lockbox mechanism; and
an updating module for updating the invoice to indicate receipt of payment.

19. A computer implemented method for invoice presentment and reconciliation wherein the method is executed by a programmed computer processor which communicates via a computer based network, the method comprising:
receiving, at a server, a batch upload of a plurality of invoices from a biller;
presenting at least one invoice of the plurality of invoices to a payor over the computer based network;
receiving lockbox information at the server from a lockbox provider, wherein the lockbox information comprises payment information relating to a payor payment remitted to the lockbox;
comparing the payment information with the invoice information at the server to determine whether the payment information matches the invoice information;
integrating the payment information from the lockbox and the invoice information at the server to create reconciliation information using the programmed computer processor;
presenting the reconciliation information to the biller;
enabling the payor and the biller to conduct an online reconciliation of the invoice over the computer based network, wherein the online reconciliation may comprise any of modifying, disputing, approving, and authorizing the invoice; and
enabling the biller and the payor to conduct a collaborative dispute resolution process over the computer based network.

20. The system of claim 5, further comprising a receiving module for receiving a batch upload of a plurality of invoices from a biller, wherein the invoice presented to the payor is at least one of the plurality of invoices.
